(19) United States
(12) Patent Application Publication
(10) Pub. No.: US 2020/0279252 A1
(43) Pub. Date: Sep. 3, 2020

(54) INFORMATION PROCESSING APPARATUS, SETTLEMENT APPARATUS, AND INFORMATION PROCESSING METHOD

(71) Applicant: TOSHIBA TEC KABUSHIKI KAISHA, Tokyo (JP)

(72) Inventor: Yuji HAYASHI, Tagata Shizuoka (JP)

(73) Assignee: TOSHIBA TEC KABUSHIKI KAISHA, Tokyo (JP)

(21) Appl. No.: 16/690,019

(22) Filed: Nov. 20, 2019

(30) Foreign Application Priority Data
Mar. 1, 2019 (JP) 2019-037770

(51) Int. Cl. G06Q 20/38; G06Q 30/02; G06F 9/54

(52) U.S. Cl. CPC G06Q 20/387; G06F 9/542; G06Q 30/0238; G06Q 30/0211

(57) ABSTRACT

An information processing apparatus includes an input unit, a setting unit, and an inhibition unit. The input unit inputs designation of a coupon that is associated with a benefit provided for a settlement person of a transaction. The setting unit sets, as an application coupon, the coupon that is a target of the designation input by the input unit. The inhibition unit inhibits the setting unit from setting the coupon that is the target of the designation input by the input unit as the application coupon when the coupon that is the target of the designation is not allowed to be used in combination with a previously set application coupon.

### CROSS-REFERENCE TO RELATED APPLICATION

This application is based upon and claims the benefit of priority from Japanese Patent Application No. 2019-037770, filed Mar. 1, 2019, the entire contents of which are incorporated herein by reference.

### FIELD

Embodiments described herein relate generally to an information processing apparatus, a settlement apparatus, and an information processing method.

### BACKGROUND

There may be a case where a plurality of coupons that can be used in the same shop are distributed and the use of some combinations of coupons is not allowed. In this case, whether or not to limit the use of a combination of coupons depends on determination of a clerk. Therefore, an unallowable combination of coupons may be used due to a clerk's mistake. Under these circumstances, it is desirable to appropriately perform application of coupons.

### DESCRIPTION OF THE DRAWINGS

FIG. 1 is a perspective view illustrating the external appearance of a self-checkout apparatus according to one embodiment;

FIG. 2 is a block diagram illustrating a main circuit configuration of the self-checkout apparatus illustrated in FIG. 1;

FIG. 3 is a flowchart illustrating information processing by a processor illustrated in FIG. 2;

FIG. 4 is a diagram illustrating a second error screen as an example; and

FIG. 5 is a diagram illustrating a second error screen as another example.

### DETAILED DESCRIPTION

Embodiments disclosed herein provide an information processing apparatus that can appropriately perform application of coupons, a settlement apparatus, and an information processing method.

In general, according to one embodiment, an information processing apparatus includes input means, setting means, and inhibition means. The input means inputs designation of a coupon that is associated with a benefit provided for a settlement person of a transaction. The setting means sets, as an application coupon, the coupon that is a target of the designation input by the input means. The inhibition means inhibits the setting means from setting the coupon that is the target of the designation input by the input means as the application coupon when the coupon that is the target of the designation is not allowed to be used in combination with the application coupon that is previously set by the setting means. Alternatively, the information processing apparatus may include an input device and a processing circuit. The input device can receive designations of coupons. The processing circuit can set the first coupon and set or inhibit setting of the second coupon.

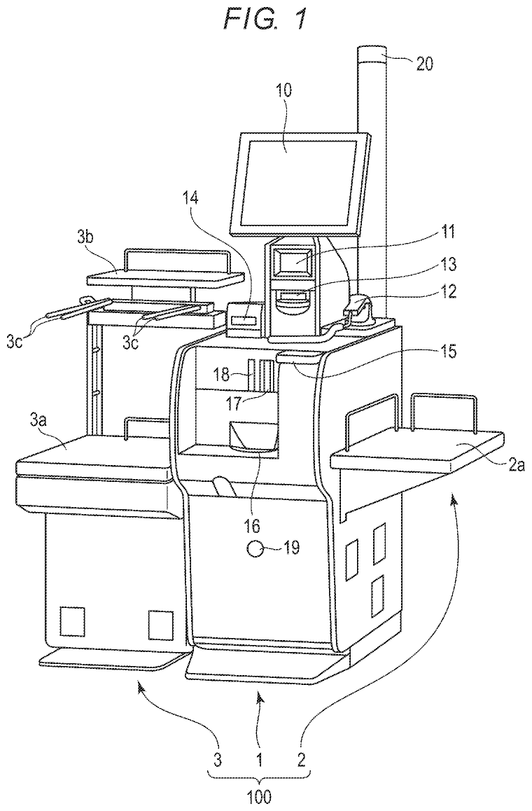

Hereinafter, an example of an embodiment will be described using the drawings. In the embodiment, a self-checkout apparatus as an information processing apparatus will be described as an example. FIG. 1 is a perspective view illustrating the external appearance of a self-checkout apparatus 100 according to the embodiment. The self-checkout apparatus 100, according to the embodiment, will also be referred to as “self-checkout point-of-sale (POS) terminal” or “automated checkout apparatus”. The self-checkout apparatus 100 is operated by a customer. Accordingly, the customer is an operator of the self-checkout apparatus 100. However, the clerk may also be the operator of the self-checkout apparatus 100.

The self-checkout apparatus 100 includes a main body 1 and weighing units 2 and 3. The main body 1 includes a touch panel 10, a scanner window 11, a handy scanner 12, a receipt dispensing port 13, a card insertion port 14, a coin deposit tray 15, a receiving tray 16, a bill insertion port 17, a bill discharge port 18, a human presence sensor 19, and a signal lamp 20.

The touch panel 10 displays various screens for notifying the operator of various information. A part of the various screens configures a graphical user interface (GUI), and the touch panel 10 receives a touch operation for inputting an instruction through the GUI. The scanner window 11 is formed by covering an opening formed in the main body 1 with a transparent resin, glass, or the like. Through the scanner window 11, a commodity that is held up to the front of the scanner window 11 by the operator can be scanned by a fixed scanner disposed inside the main body 1. The fixed scanner will be described below.

The handy scanner 12 acquires a commodity code for identifying a commodity. In addition, the handy scanner 12 acquires a coupon code for identifying a coupon. As the handy scanner 12, a well-known device capable of optically reading a barcode, a two-dimensional code, or the like that is formed to be optically readable can be adopted. In addition, as the handy scanner 12, a well-known device that acquires data stored in a wireless tag by wireless communication can be adopted.

The receipt dispensing port 13 is a slit-shaped opening for discharging a receipt to the outside of the main body 1. The card insertion port 14 is a slit-shaped opening for inserting a card into the main body 1 and for discharging the card to the outside of the main body 1.

The coin deposit tray 15 receives coins deposited by the operator for settlement. An opening is formed in the bottom surface of the coin deposit tray 15. The coins received by the coin deposit tray 15 are incorporated from the opening into the main body 1. The receiving tray 16 receives coins discharged from the main body 1 as change. The bill insertion port 17 is a slit-shaped opening for incorporating bills inserted by the operator for settlement into the main body 1. The bill discharge port 18 is a slit-shaped opening for discharging bills from the main body 1 as change or the like. The bill discharge port 18 holds bills in a state where a part of the bills protrudes to the outside of the main body 1.

The human presence sensor 19 detects the presence of a human at a position where the operator for operating the self-checkout apparatus 100 stands. That is, when a human that may be the operator is positioned in front of the self-checkout apparatus 100, the human presence sensor 19 detects this human. As the human presence sensor 19, for example, a well-known device using an infrared sensor or an optical sensor can be used. The signal lamp 20 executes a lighting operation for notifying an apparatus state.

The weighing unit 2 includes a table 2a for placing unregistered commodities. The weighing unit 2 weighs the total weight of commodities placed on the table 2a. The weighing unit 3 includes: tables 3a and 3b for placing registered commodities; and an arm 3c for hanging a bag into which registered commodities are put. The weighing unit 3 weighs the total weight of the commodities that are placed on the tables 3a and 3b and the commodities that are put into the bag hanging on the arm 3c.

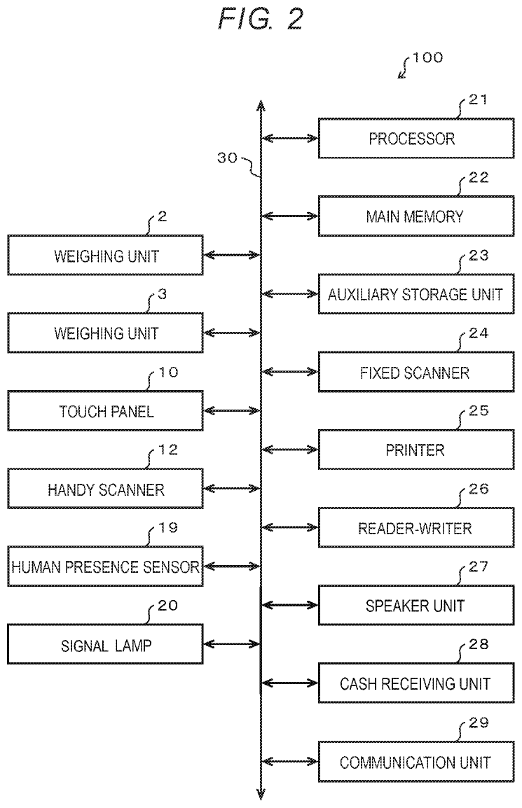

FIG. 2 is a block diagram illustrating a main circuit configuration of the self-checkout apparatus 100. In FIG. 2, the same components as those of FIG. 1 are represented by the same reference numerals, and the detailed description thereof will not be repeated. As illustrated in FIG. 2, in addition to the weighing units 2 and 3, the touch panel 10, the handy scanner 12, the human presence sensor 19, and the signal lamp 20, the self-checkout apparatus 100 further includes a processor 21, a main memory 22, an auxiliary storage unit 23, a fixed scanner 24, a printer 25, a reader-writer 26, a speaker unit 27, a cash receiving unit 28, a communication unit 29, and a transmission line 30. The processor 21, the main memory 22, the auxiliary storage unit 23, the fixed scanner 24, the printer 25, the reader-writer 26, the speaker unit 27, the cash receiving unit 28, and the communication unit 29 are stored in the main body 1. In addition, the weighing units 2 and 3, the touch panel 10, the handy scanner 12, the processor 21, the main memory 22, the auxiliary storage unit 23, the fixed scanner 24, the printer 25, the reader-writer 26, the speaker unit 27, the cash receiving unit 28, and the communication unit 29 are connected to each other via the transmission line 30. The processor 21, the main memory 22, and the auxiliary storage unit 23 are connected to each other via the transmission line 30 such that a computer for executing information processing to control the self-checkout apparatus 100 is configured.

The processor 21 corresponds to a central part of the computer. The processor 21 controls various parts so as to implement various functions of the self-checkout apparatus 100 by executing information processing based on an information processing program such as an operating system, middleware, or an application program stored in the main memory 22 or the auxiliary storage unit 23.

The main memory 22 corresponds to a main memory part of the computer. The main memory 22 includes a non-volatile memory area and a volatile memory area. The main memory 22 stores the above-described information processing program in the non-volatile memory area. In addition, the main memory 22 may store data required for the processor 21 to execute the information processing in the non-volatile or volatile memory area. The main memory 22 may use the volatile memory area as a work area where data is appropriately rewritten by the processor 21.

The auxiliary storage unit 23 corresponds to an auxiliary storage part of the above-described computer. The auxiliary storage unit 23 stores data used for the processor 21 to execute various processes or data generated during a process of the processor 21. The auxiliary storage unit 23 may also store the above-described information processing program. As the auxiliary storage unit 23, for example, an electrically erasable programmable read-only memory (EEPROM), a hard drive disk (HDD), or a solid state drive (SSD) can be used.

The fixed scanner 24 acquires a commodity code for identifying a commodity. In addition, the fixed scanner 24 acquires a coupon code for identifying a coupon. As the fixed scanner 24, a well-known device that images a barcode, a two-dimensional code, or the like held up to the front of the scanner window 11 and identifies data represented by the barcode, the two-dimensional code, or the like through image processing can be adopted. In addition, as the fixed scanner 24, a well-known device that optically reads a barcode, a two-dimensional code, or the like held up to the front of the scanner window 11 using laser light can be adopted. As the fixed scanner 24, a device having a function of identifying a commodity using an object recognition technique based on features of an image of the commodity itself may be adopted. In addition, as the fixed scanner 24, a well-known device that acquires data stored in a wireless tag by wireless communication can be adopted.

The printer 25 includes a receipt printer and a journal printer. The receipt printer dispenses various vouchers by printing various information on a receipt sheet. Examples of the various vouchers include a receipt on which the content and the like of a commercial transaction are printed. The voucher dispensed by the receipt printer is discharged from the receipt dispensing port 13 to the outside of the main body 1. The journal printer prints journal data including information printed on the receipt sheet by the receipt printer on a journal sheet. The journal sheet remains in the main body 1 as long as it is not taken out by a maintenance person. The journal data may be stored in the auxiliary storage unit 23 and may be optionally printed on the receipt sheet by the receipt printer.

The reader-writer 26 reads data recorded in a portable recording medium. In addition, the reader-writer 26 writes data into the recording medium. As the reader-writer 26, a well-known device that reads and writes data in a state where it is in contact with a magnetic card, an integrated circuit (IC) card, or the like inserted into the card insertion port 14 by the customer can be adopted. In addition, as the reader-writer 26, for example, a well-known device that reads and writes data in a state where it is not in contact with a contactless IC card or the like can be adopted. Examples of the above-described recording medium include a point card and an IC card for settlement. The reader-writer 26 may read a coupon code from a recording medium such as a membership card in which a coupon code is recorded.

The speaker unit 27 includes a speaker and a drive circuit. The speaker unit 27 outputs any sound under the control of the processor 21. The cash receiving unit 28 counts coins incorporated from the opening of the coin deposit tray 15 into the main body 1 per denomination and then stores the coins. The cash receiving unit 28 discharges coins to the receiving tray 16 as change or the like. The cash receiving unit 28 counts bills inserted from the bill insertion port 17 per denomination and stores the bills. The cash receiving unit 28 discharges bills from the bill discharge port 18 as change.

The communication unit 29 is connected to an in-shop network such as a local area network (LAN) or a communication network such as the Internet, and communicates with any apparatus such as a POS server. The transmission line 30 includes an address bus, a data bus, and a control signal line, and transmits data and a control signal to be transferred between the respective parts connected to each other.

Next, an operation of the self-checkout apparatus 100 having the above-described configuration will be described. When the self-checkout apparatus 100 is set to an operation mode where a process for checking out commodities purchased by a customer is performed in response to an operation of the customer, the processor 21 executes information processing described below.

The main memory 22 or the auxiliary storage unit 23 stores the information processing program described below in detail regarding the information processing. When hardware of the self-checkout apparatus 100 is transferred, the information processing program may be stored in the main memory 22 or the auxiliary storage unit 23 or may be transferred separately from the hardware. In the latter case, the information processing program is transferred via a network or a removable recording medium such as a magnetic disk, a magneto-optic disk, an optical disk, or a semiconductor memory in which the information processing program is recorded. In the latter case, a case can be assumed in which the information processing program that is provided as a version-up program and is written in the auxiliary storage unit 23 is rewritten with the same type of another information processing program that is previously stored in the main memory 22 or the auxiliary storage unit 23.

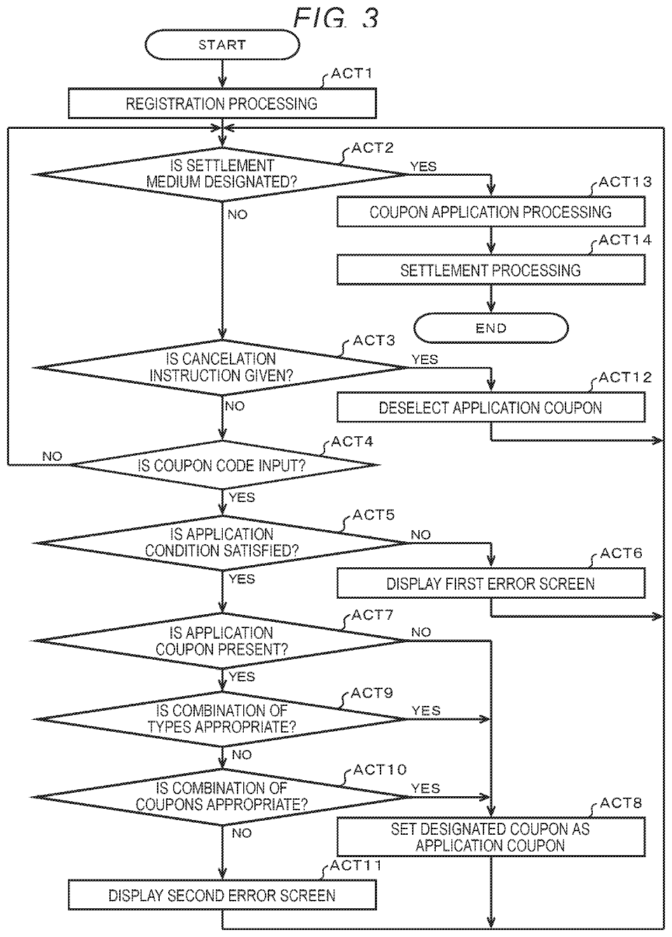

FIG. 3 is a flowchart illustrating the information processing by the processor 21. The content of the following processing is merely exemplary and, for example, change in the order of a part of the processing, omission of a part of the processing, or addition of another processing can be appropriately made.

In ACT 1, the processor 21 executes registration processing. In the registration processing, commodities to be purchased by the customer are registered as purchase commodities. For example, the processor 21 updates a commodity table such that the commodity table includes a commodity code that is input using the touch panel 10 or a commodity code that is acquired by the handy scanner 12 or the fixed scanner 24. The commodity table is a data table showing a list of purchased commodities and is stored in, for example, the main memory 22 or the auxiliary storage unit 23. That is, the commodity table is a data table showing the content of commodity sales as an example of a transaction. Thus, by the processor 21 executing the information processing based on the information processing program, a computer including the processor 21 as a central part functions as the registration unit configured to register the content of a transaction. For example, after completion of the commodity registration is declared by a predetermined operation in the touch panel 10, the processor 21 proceeds to ACT 2.

In ACT 2, the processor 21 checks whether or not a settlement medium used for settling the price of registered purchase commodities is designated. When the designation cannot be checked, the processor 21 determines NO and proceeds to ACT 3. In ACT 3, the processor 21 checks whether or not a cancellation instruction described below is given. When the cancellation instruction cannot be checked, the processor 21 determines NO and proceeds to ACT 4. In ACT 4, the processor 21 checks whether or not a coupon code is input. When the input of the coupon code cannot be checked, the processor 21 determines NO and returns to ACT 2. Thus, in ACT 2 to ACT 4, the processor 21 waits for any one of the designation of the settlement medium, the cancellation instruction, and the input of the coupon code. At this time, the processor 21 displays, for example, a GUI screen on the touch panel 10. This GUI screen shows one or more buttons for designating the settlement medium that can be used for the settlement. In addition, the GUI screen shows a button for the cancellation instruction. In addition, when the customer wants to apply a coupon, the GUI screen shows a character message that guides the customer to perform an operation for inputting a coupon code of the coupon to be applied.

When the customer wants to apply a coupon belonging to the customer to the present transaction, a coupon code of the coupon is read by the handy scanner 12 or the fixed scanner 24. Accordingly, the handy scanner 12 or the fixed scanner 24 inputs the coupon code and notifies the processor 21 of the input coupon code. Through this notification, the processor 21 determines YES in ACT 4 and proceeds to ACT 5. The coupon code may be input through the touch panel 10 or the reader-writer 26. Thus, a device used for inputting the coupon code among the touch panel 10, the handy scanner 12, the fixed scanner 24, and the reader-writer 26 is an example of the input unit configured to input designation of a coupon.

In ACT 5, the processor 21 checks whether or not an application condition of the coupon that is identified by the input coupon code is satisfied. The application condition is previously determined depending on coupons, and examples thereof include “the price of purchase commodities is 1000 yen or more” and “purchase commodities include a commodity having a commodity code OOO”. In addition, the application condition may include an expiration date or a valid shop. Referring to a data table that can be referred to check the application condition predetermined for the coupon identified by the coupon code, the processor 21 determines the application condition of the coupon identified by the input coupon code, for example, based on the coupon code. The data table may be stored in the main memory 22 or the auxiliary storage unit 23 or may be stored in any other recording device such as a recording device included in a POS server. When the application condition is not satisfied, the processor 21 determines NO and proceeds to ACT 6.

In ACT 6, the processor 21 displays a first error screen on the touch panel 10. The first error screen is a screen for notifying the customer that the designated coupon cannot be applied because the application condition is not satisfied. At a predetermined timing at which, for example, the customer declares that the notification on the first error screen is checked or the display time of the first error screen reaches a predetermined time, the processor 21 ends the display of the first error screen and returns to the wait state of ACT 2 to ACT 4.

When the application condition is satisfied, the processor 21 determines YES in ACT 5 and proceeds to ACT 7. In ACT 7, the processor 21 checks whether or not an application coupon that is previously set is present. The application coupon is a coupon that is set to be applied to the present transaction as described below. When the application coupon is not present, the processor 21 determines NO and proceeds to ACT 8.

In ACT 8, the processor 21 sets the coupon that is identified by the input coupon code as the application coupon. For example, the processor 21 adds the input coupon code to a data table showing a list of application coupons. Thus, by the processor 21 executing the information processing based on the information processing program, a computer including the processor 21 as a central part functions as the setting unit configured to set the application coupon. Next, the processor 21 returns to the wait state of ACT 2 to ACT 4. Thus, after setting the application coupon, the customer can designate a coupon code of another coupon. When another coupon code is input in a state where even one application coupon is set, the processor 21 proceeds to ACT 7. In this case, the processor 21 determines YES and proceeds to ACT 9.

In ACT 9, the processor 21 checks whether or not a combination (hereinafter, referred to as “type combination”) of a type of the coupon (hereinafter, referred to as “designated coupon”) that is identified by the coupon code input at this time and a type of the application coupon that is previously set is appropriate. For example, the type of the coupon is determined depending on a providing form of a benefit provided by the application of the coupon. That is, for example, it is assumed that a plurality of coupons of which benefits are discount in a given discount amount from the price of a target commodity included in purchase commodities have the same type (hereinafter, referred to as “first type”) even when the discount amounts, the application conditions, and the like thereof are different from each other. That is, for example, it is assumed that a plurality of coupons of which benefits are discount at a given discount ratio from the price of a target commodity included in purchase commodities have the same type (hereinafter, referred to as “second type”) even when the discount ratios, the application conditions, and the like thereof are different from each other. In addition, for example, it is assumed that a plurality of coupons of which benefits are discount in a given discount amount from the sum of individual prices of purchase commodities, that is, from the subtotal amount have the same type (hereinafter, referred to as “third type”) even when the discount amounts, the application conditions, and the like thereof are different from each other. In addition, for example, it is assumed that a plurality of coupons of which benefits are discount at a given discount ratio from the subtotal amount have the same type (hereinafter, referred to as “fourth type”) even when the discount ratios, the application conditions, and the like thereof are different from each other. In addition, for example, it is assumed that a plurality of coupons of which benefits are discount in a discount amount or at a discount ratio that varies depending on ranks set for customers have the same type (hereinafter, referred to as “fifth type”) even when the discount amounts or discount ratios, the application conditions, and the like thereof are different from each other. For example, the first type and the second type can be used in combination with another type, but the third type, the fourth type, and the fifth type cannot be used in combination with each other. In this case, for example, when the type of the designated coupon is the first type or the second type, the designated coupon can be used in combination with the application coupon irrespective of the type of the application coupon. Therefore, the processor 21 determines that the type combination is appropriate. In addition, in a case where it is assumed that the type of the designated coupon is the third type, the fourth type, or the fifth type, when the application coupon is not a coupon having any one of the third type, the fourth type, or the fifth type, the processor 21 determines that the type combination is appropriate; and when the application coupon is a coupon having any one of the third type, the fourth type, or the fifth type, the processor 21 determines that the type combination is not appropriate.

Whether or not the types of coupons and the type combination are appropriate may be appropriately determined depending on, for example, an operation policy of a shop where the self-checkout apparatus 100 is provided. The processor 21 may execute the determination in ACT 9 through a process that is defined by the information processing program according to a specific regulation as described above or may execute the determination in ACT 9 with respect to a setting table showing whether or not each type combination is appropriate.

When the type combination is appropriate, the processor 21 determines YES in ACT 9 and proceeds to ACT 8. When the type combination is not appropriate, the processor 21 determines NO in ACT 9 and proceeds to ACT 10. In ACT 10, the processor 21 checks whether or not a combination (hereinafter, referred to as “coupon combination”) of the designated coupon and the application coupon is appropriate. When the coupon combination is appropriate, the processor 21 determines YES and proceeds to ACT 8.

As described above, when the application coupon is present and the type combination is appropriate or when the application coupon is present, the type combination is not appropriate, and the coupon combination is appropriate, the processor 21 proceeds to ACT 8. That is, even in a case where the type combination is not appropriate, when the use of the combination of the designated coupon and the application coupon is exceptionally allowed, the processor 21 proceeds to ACT 8. For example, a plurality of coupons that are issued under the same project may be allowed to be used in combination. In this case, the coupons that are issued under the same project have the same type, and thus the type combination may not be appropriate. However, the processor 21 determines that the coupon combination is appropriate in ACT 10. In this case, a project code for identifying a project under which each coupon is issued can be checked based on the coupon code or with respect to the setting table based on the coupon code. For example, when the project code of the designated coupon matches the project code of the application coupon, the processor 21 determines that the coupon combination is appropriate.

Whether or not the coupon combination is appropriate may be appropriately determined depending on, for example, an operation policy of a shop where the self-checkout apparatus 100 is provided. The processor 21 may execute the determination in ACT 9 through a process that is defined by the information processing program according to a specific regulation as described above or may execute the determination in ACT 9 with respect to a setting table showing whether or not each coupon combination is appropriate. When the processor 21 determines YES in ACT 9 or ACT 10 and executes ACT 8 again, the processor 21 adds and sets the designated coupon as a new application coupon without deselecting the application coupon that is previously set.

When the coupon combination is also not appropriate, the processor 21 determines NO in ACT 10 and proceeds to ACT 11. In ACT 11, the processor 21 displays a second error screen on the touch panel 10. The second error screen is a screen for notifying the customer that the coupon that is designated at this time cannot be applied due to a relationship with the application coupon that is previously set. At a predetermined timing at which, for example, the customer declares that the notification on the second error screen is checked or the display time of the second error screen reaches a predetermined time, the processor 21 ends the display of the second error screen and returns to the wait state of ACT 2 to ACT 4.

That is, when the processor 21 determines NO in ACT 10, the processor 21 avoids the execution of ACT 8. Thus, by the processor 21 executing the information processing based on the information processing program to inhibit the designated coupon from being set as the application coupon, a computer including the processor 21 as a central part functions as the inhibition unit.

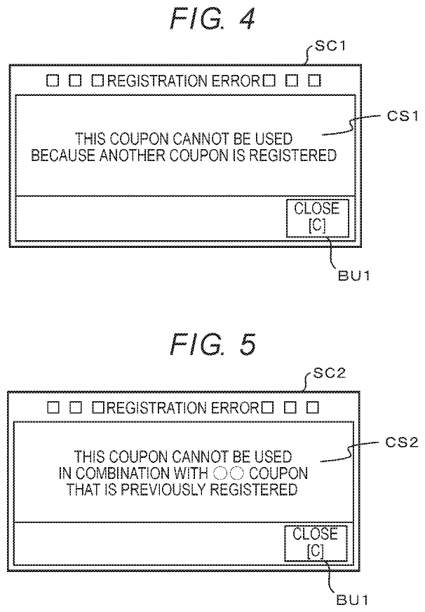

FIG. 4 is a diagram illustrating a second error screen SC1 as an example. The second error screen SC1 includes a character string CS1 and a button BU1. The character string CS1 is a character message showing that the coupon designated at this time cannot be used without showing whether or not the coupon combination is not appropriate. The button BU1 is a button for receiving the declaration of the customer showing that the notification on the second error screen SC1 is checked.

FIG. 5 is a diagram illustrating a second error screen SC2 as another example. The second error screen SC2 is a screen in which the character string CS1 on the second error screen SC1 is replaced with a character string CS2. The character string CS2 is a character message showing that the coupon designated at this time cannot be used by showing whether or not the coupon combination is not appropriate.

The content of the error screen may be appropriately determined by a designer, a manager, or the like of the self-checkout apparatus 100. Alternatively, one error screen that is designated by the manager or the like among a plurality of error screens determined by the designer may be set as a screen of a display target in ACT 11. The processor 21 may display a predetermined error screen to be displayed in ACT 11 on the touch panel 10.

When the second error screen SC2 is displayed, the processor 21 determines an application coupon of which combination with the designated coupon is not appropriate. The processor 21 sets a coupon name or the like based on which the customer can identify the corresponding application coupon to the portion “OO coupon” in the character string CS2. Thus, when the second error screen SC2 is displayed, the customer can easily recognize an unallowable combination of coupons.

When the processor 21 is in the wait state of ACT 2 to ACT 4 and the setting of the application coupon is canceled, the customer executes the cancellation instruction by touching a button in the GUI screen displayed on the touch panel 10. As a result, the processor 21 determines YES in ACT 3 and proceeds to ACT 12. In ACT 12, the processor 21 deselects all the application coupons. The processor 21 may display a screen showing a list of application coupons on the touch panel 10 such that only designated coupons can be deselected from the application coupons. Next, the processor 21 returns to the wait state of ACT 2 to ACT 4.

The customer designates the settlement medium for the settlement by touching a button in the GUI screen displayed on the touch panel 10 in a state where the setting of the application coupon is in a desired state, for example, the coupon is not used. As a result, the processor 21 determines YES in ACT 2 and proceeds to ACT 13. In ACT 13, the processor 21 executes coupon application processing. That is, for example, the processor 21 executes a process for providing the customer with a benefit that is associated with the coupon set as the application coupon. For example, when a coupon belonging to the first type is set as the application coupon, the processor 21 sets an amount obtained by subtracting a given discount amount from the price of a target commodity as a selling price of the commodity during the calculation of the amount of settlement. When a coupon set as the application coupon is not present, the processor 21 only needs to check that the application coupon is not present in ACT 13. Thus, by the processor 21 executing the information processing based on the information processing program, a computer including the processor 21 as a central part functions as the providing unit configured to provide a benefit associated with the application coupon.

In ACT 14, the processor 21 executes settlement processing of settling the amount of settlement using the designated settlement medium. This settlement processing may be the same processing as processing that is performed by the same type of an existing self-checkout apparatus. In addition, the settlement medium may be, for example, cash, a credit card, electronic money, virtual currency, a prepaid card, a gift certificate, or any other medium. Thus, by the processor 21 executing the information processing based on the information processing program, a computer including the processor 21 as a central part functions as the settlement unit. After the end of the settlement processing, the processor 21 ends the information processing illustrated in FIG. 3. After the end of the settlement processing, the processor 21 may cause the printer 25 to dispense a receipt.

As described above, with the self-checkout apparatus 100, any coupon included in unallowable combinations of coupons is inhibited from being set as the application coupon. Accordingly, coupons that cannot be used in combination can be prevented from being used in combination, and the application of coupons can be appropriately executed.

This embodiment can be modified as follows in various ways. The embodiment is also applicable to a POS terminal, a cash register, or the like called a face-to-face type where the operator is a clerk.

In addition, the embodiment is also applicable to a registration apparatus or a settlement apparatus in a self-service checkout system. In the case of the registration apparatus, for example, ACT 2 in FIG. 3 is changed to a process of checking whether or not an instruction of transfer to the settlement apparatus is given. ACT 13 and ACT 14 are changed to a process of transferring the commodity table and the data table showing a list of the application coupons to the settlement apparatus. In the case of the settlement apparatus, for example, ACT 1 illustrated in FIG. 3 is changed to a process of receiving a commodity table generated by the registration processing in the registration apparatus.

Either ACT 9 or ACT 10 may be omitted.

In at least one of ACT 6 and ACT 11, the processor may return to the wait state of ACT 2 to ACT 4 in response to a special operation of the clerk.

For example, the benefit may be any other benefit such as the adding of a point, the issuing of another coupon, or the giving of a gift.

A part or all of the respective functions that are implemented by the processor 21 through the information processing can also be implemented by hardware that executes information processing not based on a program, for example, a logic circuit. In addition, each of the respective functions can also be implemented by a combination of the hardware such as a logic circuit and a software control.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
an input device for inputting designations of coupons that are associated with benefits provided for a settlement person of a transaction; and
a processing circuit having programmed instructions to:
set a first coupon that is a target of a first designation received by the input device;
set a second coupon that is the target of a second designation received by the input device in response to determining that a combination of the first coupon and the second coupon is allowed to be applied in the transaction; and
inhibit setting the second coupon in response to determining that the combination is not allowed to be applied in the transaction.

2. The information processing apparatus of claim 1, wherein the first coupon has a first benefit and the second coupon has a second benefit, wherein each of the first benefit and the second benefit is associated with a respective type of benefit, and wherein the respective type of benefit for each of the first benefit and the second benefit is (i) a first type including a given discount amount from a price of a target commodity included in the transaction, (ii) a second type including a given discount ratio from the price of the target commodity included in the transaction, (iii) a third type including a given discount amount from a subtotal amount based on prices of a plurality of commodities in the transaction, (iv) a fourth type including a given discount ratio from the subtotal amount, or (v) a fifth type including a given discount in a discount amount or at a discount ratio that varies depending on the settlement person.

3. The information processing apparatus of claim 2, wherein the respective type of benefit of the first benefit and the second benefit is different.

4. The information processing apparatus of claim 3, wherein the processing circuit has programmed instructions to determine that the combination of the first coupon and the second coupon is not allowed to be applied in the transaction in response to the respective type of benefit of the first coupon and the second coupon being one of the third type, the fourth type, or the fifth type.

5. The information processing apparatus of claim 3, wherein the processing circuit has programmed instructions to determine that the combination of the first coupon and the second coupon is allowed to be applied in the transaction in response to (a) the respective type of benefit of the first coupon being one of the first type or the second type and (b) the respective type of benefit of the second coupon being one of the third type, the fourth type, or the fifth type.

6. The information processing apparatus of claim 2, wherein the respective type of benefit of the first benefit and the second benefit is the same.

7. The information processing apparatus of claim 6, wherein the processing circuit has programmed instructions to determine that the combination of the first coupon and the second coupon is not allowed to be applied in the transaction in response to the respective type of benefit of the first coupon and the second coupon being one of the third type, the fourth type, or the fifth type.

8. The information processing apparatus of claim 6, wherein the processing circuit has programmed instructions to determine that the combination of the first coupon and the second coupon is not allowed to be applied in the transaction in response to (a) the respective type of benefit of the first coupon and the second coupon being one of the first type or the second type and (b) the first coupon and the second coupon being associated with the same target commodity.

9. The information processing apparatus of claim 6, wherein the processing circuit has programmed instructions to determine that the combination of the first coupon and the second coupon is allowed to be applied in the transaction in response to (a) the respective type of benefit of the first coupon and the second coupon being one of the first type or the second type and (b) the first coupon and the second coupon being associated with a different target commodity.

10. The information processing apparatus of claim 1, wherein the processing circuit has programmed instructions to inhibit setting the second coupon independent of the first coupon in response to determining that the second coupon does not meet an application condition for the transaction, the application condition including at least one of a minimum total price for the transaction, an associated commodity being included in the transaction, an expiration date, or a valid shop.

11. The information processing apparatus of claim 1, further comprising an output device for notifying an operator, wherein the processing circuit has programmed instructions to provide a notification to the settlement person through the output device indicating that the combination is not allowed to be applied in the transaction.

12. The information processing apparatus of claim 11, wherein the processing circuit has programmed instructions to allow the settlement person to select between applying the first coupon or the second coupon following the notification being provided to the settlement person.

13. The information processing apparatus of claim 11, wherein the output device is a touch panel.

14. The information processing apparatus of claim 11, wherein the input device and the output device are the same device.

15. The information processing apparatus of claim 1, wherein the input device includes at least one of a touch panel, a hand scanner, a fixed scanner, or a reader-writer.

16. A settlement apparatus comprising:
an input device for inputting designation of a coupon that is associated with a benefit provided for a settlement person of a transaction;
a processing circuit having programmed instructions to:
set, as an application coupon, the coupon that is a target of designation input by the input device;
inhibit setting the coupon that is the target of the designation input by the input device as the application coupon when the coupon that is the target of the designation is not allowed to be used in combination with a previously set application coupon;
execute settlement processing for settling the transaction; and
provide a benefit associated with the previously set application coupon and, if not inhibited, the application coupon regarding the settlement processing.

17. The settlement apparatus of claim 16, wherein the processing circuit has programmed instructions to register a content of the transaction.

18. The settlement apparatus of claim 16, wherein, when the benefit associated with the coupon that is the target of the designation input by the input device and a benefit associated with the previously set application coupon have the same providing form but are different from each other, the processing circuit has programmed instructions to inhibit setting the coupon that is the target of the designation as the application coupon.

19. The settlement apparatus of claim 16, wherein the processing circuit has programmed instructions to notify an operator that the previously set application coupon is not allowed to be used in combination with the coupon that is the target of the designation input.

20. A method of causing a computer provided in an information processing apparatus including an input device for inputting a designation of a coupon that is associated with a benefit provided for a settlement person of a transaction, the method comprising:
setting, as an application coupon, the coupon that is a target of designation input by the input device; and
inhibiting the setting of the coupon that is the target of the designation input by the input device as the application coupon when the coupon that is the target of the designation is not allowed to be used in combination with a previously set application coupon.
